(19) United States
(12) Patent Application Publication
(10) Pub. No.: US 2026/0209091 A1
(43) Pub. Date: Jul. 23, 2026

(54) REMOVAL OF METAL IONS IN WATER FOR ELECTROLYSIS

(71) Applicant: University of Houston System, Houston, TX (US)

(72) Inventors: Zhifeng REN, Pearland, TX (US); Minghui NING, Houston, TX (US); Yu WANG, Houston, TX (US)

(73) Assignee: University of Houston System, Houston, TX (US)

(21) Appl. No.: 19/157,344

(22) PCT Filed: Feb. 19, 2024
(86) PCT No.: PCT/US2024/016384

§ 371 Date: Aug. 15, 2025

Related U.S. Application Data
(60) Provisional application No. 63/446,678, filed on Feb. 17, 2023.

(51) Int. Cl. C02F 1/52; C02F 101/20; C02F 103/02; C02F 103/08; C25B 1/04; C25B 11/067; C25B 13/02; C25B 15/08

(52) U.S. Cl. CPC C02F 1/5272; C25B 1/04; C25B 11/067; C25B 13/02; C25B 15/085; C02F 2101/20; C02F 2103/02; C02F 2103/08

(57) ABSTRACT

A method for reducing the metal content in a water source includes dissolving an amount of a solubilizing anion in a low grade water comprising one or more cations under conditions suitable to formed a suspension comprising insoluble solubilizing anion-cation complexes wherein the anion comprises; and separating the insoluble solubilizing anion-cation complexes from the suspension to obtain a higher grade water having a metal content reduced by from about 50% to about 100%.

### CROSS-REFERENCE TO RELATED APPLICATIONS

This application is a 35 U.S.C. § 371 national stage application of PCT/US2024/016384 filed Feb. 19, 2024 and entitled “Removal of Metal Ions in Water for Electrolysis,” which claims priority to U.S. Provisional Application No. 63/446,678 filed Feb. 17, 2023 and entitled “Removal of Metal Ions in Water for Electrolysis,” each of which is hereby incorporated herein by reference in its entirety for all purposes.

### TECHNICAL FIELD

The present disclosure relates generally to the production of hydrogen. More particularly the present disclosure relates to metal ion removal from water to produce water of a quality suitable for use in water electrolysis.

### BACKGROUND

Hydrogen is a clean fuel that, when consumed in a fuel cell, produces only water. These qualities make it an attractive fuel option for transportation and electricity generation applications. Exemplary applications include cars, houses and portable power. Hydrogen is an energy carrier that can be used to store, move, and deliver energy produced from other sources. Hydrogen production from water electrolysis coupled with renewable energy resources is one of the ultimate strategies to replace the fossil fuel energy system.

Today, hydrogen fuel can be produced through several methods. One of the common methods of hydrogen fuel production is electrolysis. Electrolysis is the process by which water is separated into oxygen and hydrogen. Electrolytic processes take place in an electrolyzer, which functions much like a fuel cell in reverse, instead of using the energy of a hydrogen molecule, like a fuel cell does, an electrolyzer creates hydrogen from water molecules.

Currently, ultrapure deionized water (DI) is the source of water for the most common electrolyzers such as alkaline water electrolyzers, proton exchange membrane (PEM) water electrolyzers and anion exchange membrane (AEM) water electrolyzers. Ultrapure DI water production involves expensive reverse osmosis (RO) facilities and consumes extra electricity thereby introducing additional cost to hydrogen (H₂) production. It would be economically beneficial to use a lower quality or grade of water in the production of Hz. However, the use of low grade water (e.g., tap water) in the H₂ production process is challenging due to the presence of metal species that are ubiquitous in low grade water sources.

For example, low grade water such as tap water and sea water commonly contain metals such as calcium (Ca), magnesium (Mg), aluminum (Al), manganese (Mn), zinc (Zn), arsenic (As), copper (Cu), lead (Pb), cadmium (Cd), nickel (Ni), iron (Fe), etc. Notably, water containing metal ions such as when subjected to electrolysis will form precipitates containing these metal ions (e.g., metal hydroxides) on the surface of the cathode of an electrolyzer. The precipitated metal hydroxides block the active sites of catalysts used to promote the production of H₂ such as a hydrogen evolution reaction (HER) catalyst.

### SUMMARY

Disclosed herein is a method for reducing the metal content in a water source comprising dissolving an amount of a solubilizing anion in a low grade water comprising one or more cations under conditions suitable to formed a suspension comprising insoluble solubilizing anion-cation complexes wherein the anion comprises; and separating the insoluble solubilizing anion-cation complexes from the suspension to obtain a higher grade water having a metal content reduced by from about 50% to about 100%.

Also disclosed herein is a method comprising contacting a first water with a solubilizing anion to form a second water comprising a suspension of an insoluble complex of the soluble anion and a cation wherein the first water has a resistivity of less than about 18 MΩ-cm and a conductivity of less than about 0.056 μS/cm and the second water has a resistivity that is at least 50% greater than the first water and a conductivity that is at least 50% greater than the first water.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a picture of different KOH concentrations electrolytes prepared with tap water, in accordance with aspects of the present disclosure;

FIG. 2 is a picture of tap water, tap water with K₂C₂O₄·H₂O dissolved and tap water with K₂C₂O₄·H₂O dissolved after filtration, in accordance with aspects of the present disclosure;

FIG. 3 is a picture of different KOH concentrations electrolytes prepared with K₂C₂O₄ treated tap water, in accordance with aspects of the present disclosure;

FIG. 4 is a picture of tap water, tap water with (NH₄)₂C₂O₄·H₂O dissolved, and tap water with (NH₄)₂C₂O₄·H₂O dissolved after filtration in accordance with aspects of the present disclosure;

FIG. 5 is a picture of different KOH concentrations electrolytes prepared with (NH₄)₂C₂O₄ treated tap water, in accordance with aspects of the present disclosure;

FIG. 6a shows the I-V polarization curves of the anion exchange membrane electrolyzer at 25 and 65° C. in different KOH electrolytes prepared with deionized (DI) water, as described in the Example;

FIG. 6b shows the voltages and energy consumptions of the anion exchange membrane electrolyzer at 500 mA/cm² and 65° C. in different KOH electrolytes prepared with DI water, as described in the Example;

FIG. 6c shows the voltages and energy consumptions of the anion exchange membrane electrolyzer at 1000 mA/cm² and 65° C. in different KOH electrolytes prepared with DI water, as described in the Example;

FIG. 6d shows the I-V polarization curves of the anion exchange membrane electrolyzer at 25 and 65° C. in different KOH electrolytes prepared with K₂C₂O₄ treated tap water, as described in the Example;

FIG. 6e shows the voltages and energy consumptions of the anion exchange membrane electrolyzer at 500 mA/cm² and 65° C. in different KOH electrolytes prepared with K₂C₂O₄ treated tap water, as described in the Example;

FIG. 6f shows the voltages and energy consumptions of the anion exchange membrane electrolyzer at 1000 mA/cm² and 65° C. in different KOH electrolytes prepared with K₂C₂O₄ treated tap water, as described in the Example;

FIG. 7a shows the I-V polarization curves of the anion exchange membrane electrolyzer at 25 and 65° C. in 1 M KOH prepared with K₂C₂O₄ treated tap water, as described in the Example;

FIG. 7b shows the chronopotentiometry measurement of the anion exchange membrane electrolyzer at 1 A/cm² and 65° C. in 1 M KOH prepared with K₂C₂O₄ treated tap water, as described in the Example;

FIG. 7c shows the I-V polarization curves of the anion exchange membrane electrolyzer at 25 and 65° C. in 1 M KOH and tap water, as described in the Example;

FIG. 7d shows the chronopotentiometry measurement of the anion exchange membrane electrolyzer at 1 A/cm² and 65° C. in 1 M KOH and tap water, as described in the Example;

FIG. 8a depicts the scanning electron microscopy image of the NiMoN after the chronopotentiometry test in 1 M KOH and tap water, as described in the Example;

FIGS. 8b-8g provide scanning electron microscopy elemental mapping of the NiMoN after the chronopotentiometry test in 1 M KOH and tap water, as described in the Example;

FIG. 8h provide the energy dispersive spectroscopic analysis and contents of different elements of the NiMoN after the chronopotentiometry test in 1 M KOH and tap water, as described in the Example;

FIGS. 9a and 9b provide the energy dispersive spectroscopic analysis of a specific area on the NiMoN after the chronopotentiometry test in 1 M KOH and tap water, as described in the Example;

FIGS. 10a and 10b provide the energy dispersive spectroscopic point analysis of another specific area on the NiMoN after the chronopotentiometry test in 1 M KOH and tap water, as described in the Example;

FIG. 11 is a picture of different KOH concentrations electrolytes prepared with sea water, in accordance with aspects of the present disclosure;

FIG. 12 is a picture of sea water, sea water with KsPO₄ dissolved, K₃PO₄ treated sea water with K₂C₂O₄·H₂O dissolved, K₃PO₄ and K₂C₂O₄ treated seawater after filtration, in accordance with aspects of the present disclosure;

FIG. 13 is a picture of different KOH concentrations electrolytes prepared with KsPO₄ and K₂C₂O₄ treated sea water, in accordance with aspects of the present disclosure;

FIG. 14a shows the I-V polarization curves of the anion exchange membrane electrolyzer at 25 and 65° C. in 1 M KOH and treated sea water, as described in the Example;

FIG. 14b shows the voltages and energy consumptions of the anion exchange membrane electrolyzer at 500 and 1000 mA/cm² under 25° C. in 1 M KOH and treated sea water, as described in the Example;

FIG. 14c shows the voltages and energy consumptions of the anion exchange membrane electrolyzer at 500 and 1000 mA/cm² under 65° C. in 1 M KOH and treated sea water, as described in the Example;

FIG. 14d shows the I-V polarization curves of the anion exchange membrane electrolyzer at 65° C. in 1 M KOH prepared with different water, as described in the Example;

FIG. 14e shows the voltages and energy consumptions of the anion exchange membrane electrolyzer at 500 mA/cm² under 65° C. in 1 M KOH prepared with different water, as described in the Example;

FIG. 14f shows the voltages and energy consumptions of the anion exchange membrane electrolyzer at 1000 mA/cm² under 65° C. in 1 M KOH prepared with different water, as described in the Example;

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. In addition, where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

For the reasons previously described, in order to utilize low grade water in the production of H₂, the removal of free metal ions is desirable to allow for the long-term operation of a water electrolyzer. Thus, there is an ongoing need to develop compositions and methodologies for the rapid, cost-efficient reduction of metal ions in low grade water.

Disclosed herein are fast and low-cost methods to remove metal ions such as Ca²⁺, Mg²⁺, Al³⁺, etc. from low grade water to produce water suitable for use in electrolysis. In an aspect, the methods disclosed herein are used to provide a grade of water suitable for use in an electrolyzer and is termed a water-associated with reduced metal, a WARM.

Deionized (DI) water suitable for use in electrolysis to produce H₂ may be characterized according to ASTM D1193 and present one or more of the following features listed in Table 1:

TABLE 1

| Measurement (Unit) | Type I | Type II | Type III | Type IV |
|---|---|---|---|---|
| Resistivity (MΩ-cm) | >18 | >1 | >4 | >0.2 (200 |
| | | | | KΩ) |
| Conductivity (μS/cm) | <0.056 | <1 | <0.25 | <5 |
| pH at 25° C. | N/A | N/A | N/A | 5.0-8.0 |
| Total Organic Carbon | <50 | <50 | <200 | N/A |
| (TOC) ppb or μg/L | | | | |
| Sodium (ppb or μg/L) | <1 | <5 | <10 | <50 |
| Chloride (ppb or μg/L) | <1 | <5 | <10 | <50 |
| Silica (ppb or μg/L) | <3 | <3 | <500 | N/A |

Herein the term “low grade water” refers to water having a metal content resulting in a resistivity of less than about 18 MΩ-cm, alternatively less than about 4 MΩ-cm, alternatively less than about 1 MΩ-cm, or alternatively less than about 0.2 MΩ-cm. In an aspect of the present disclosure, low grade water refers to water having a metal ion content providing a conductivity of greater than about 0.056 μS/cm, alternatively greater than about 0.25 μS/cm, alternatively greater than about 1 μS/cm or alternatively greater than about 5 μS/cm. Nonlimiting examples of low grade water include tap water, produced water, wastewater and seawater. Herein any water source having an increased number of dissolved ions in can have a conductivity that renders the water as low grade.

In aspects of the present disclosure, a method for production of a WARM comprises introducing a source of solubilizing anions to a low grade water. Herein the solubilizing anions comprise oxalate ions (C₂O₄²⁻), phosphate ions (PO₄³⁻) or a combination thereof. The solubilizing anions may be introduced to the low grade water in amounts sufficient to reduce the metal ion content of the low grade water to some user and/or process desired level. In one or more aspects of the present disclosure, the metal ion content of the low grade water is reduced to a level that provides for at least one of the features of DI water, alternatively at least two of the features, or alternatively at least three of the features of DI water. In one or more aspects, a WARM has a total metal content resulting in a resistivity of greater than about 18 MΩ-cm, alternatively greater than about 4 MΩ-cm, alternatively greater than about 1 MΩ-cm, or alternatively greater than about 0.2 MΩ-cm. In an aspect of the present disclosure, the WARM has a metal ion content providing a conductivity of less than about 0.056 μS/cm, alternatively less than about 0.25 μS/cm, alternatively less than about 1 μS/cm or alternatively less than about 5 μS/cm. In one or more aspects, the WARM has a total organic carbon content of less than about 50 ppb, alternatively less than about 40 ppb or alternatively less than about 25 ppb. In one or more aspects, the WARM has a sodium content, chloride content or both of less than about 1 ppb, alternatively less than about 0.8 ppb or alternatively less than about 0.5 ppb.

Particularly, the amount of C₂O₄²⁻ and PO₄³⁻ introduced to the low grade water (e.g., tap water) may be sufficient to form insoluble salts of the metal ions present in the low grade water. For example, the introduction of C₂O₄²⁻ and PO₄³⁻ to the low grade water may result in the formation of insoluble salts such as CaC₂O₄, MgC₂O₄, Al₂(C₂O₄)₃, Ca₃(PO₄)₂, Mg₃(PO₄)₂, and AlPO₄.

As will be understood by one of ordinary skill in the art, at temperatures of about 25° C. and neutral pH (i.e., approximately pH 7), the solubility product constant (Kₛₚ) of CaC₂O₄, Mg₃(PO₄)₂, and AlPO₄ are 2.32×10⁻⁹, 1.04×10⁻²⁴, and 9.84×10⁻²¹, respectively which is much lower than the Kₛₚ of Ca(OH)₂ at 5.02×10⁻⁶. The small Kₛₚ of CaC₂O₄, Mg₃(PO₄)₂, and AlPO₄ suggest the C₂O₄²⁻ and PO₄³⁻ can be employed as strong agents for the low-cost and rapid removal of Ca²⁺, Mg²⁺, and Al³⁺ from low grade water. Herein “rapid removal” refers to precipitation of the insoluble salts occurring in a time frame of from about 10 seconds to about 1 minute, alternatively from about 1 minute to about 1 hour or alternatively from about 1 hour to about 24 hours.

In an aspect, a method of the present disclosure further comprises removing the precipitated insoluble salts of the metal ions from the low grade water. For example, the precipitated insoluble salts comprising CaC₂O₄, MgC₂O₄, Al₂(C₂O₄)₃, Ca₃(PO₄)₂, Mg₃(PO₄)₂, and AlPO₄ may be removed from the low grade water using any suitable methodology such as gravity precipitation, centrifugation or simple filtration to obtain a WARM.

In one or more aspects, the present method further comprises utilizing the WARM to prepare an alkaline solution, termed an alkaline WARM. An alkaline solution may be prepared by dissolving any suitable alkaline agent in the WARM. In some aspects, the alkaline agent comprises a hydroxide such as potassium hydroxide, lithium hydroxide, sodium hydroxide, rubidium hydroxide, magnesium hydroxide, barium hydroxide, calcium hydroxide, strontium hydroxide or combinations thereof in any suitable concentration. For example, the alkaline agent may comprise KOH ranging in concentration from about 1 molar (M) to about 6 M.

In one or more aspects, the method further comprises utilizing the alkaline WARM KOH-WARM) as an electrolyte in an electrolyzer (e.g. AEM). In one or more aspects, the method further comprises replenishing water consumed during the electrolysis reaction in the AEM electrolyzer with any suitable water. The suitable water may be a WARM of the type disclosed herein. In one or more aspects, the electrolyzer comprises a HER catalyst, an oxygen evolution reaction catalyst or both. In one or more aspects, the HER catalyst comprises noble metals and their alloys (e.g., Pt, Pd, Ir, Ru, Ag), transition metal catalysts such as Fe, Co, Ni, Mn, Cu, Mo, W, and nonmetal catalysts such as B, C, N, P, S, and their alloys. Nonlimiting examples of HER catalysts for use in the present disclosure include MoP, Pt/C, Pd/C, Ru/C₃N₄/C, RuO₂/Co₃O₄, Fe—CoP/Ti, and NIMoN. Nonlimiting examples of OER catalysts for use in the present disclosure include Au/Co₃O₄ core/shell nanoparticles, Co₃O₄ Pt/C, Pd/C, Ru/C₃N₄/C, RuO₂/Co₃O₄, Fe—CoP/Ti, and NiMoN.

In an aspect, an AEM electrolyzer suitable for use in the present disclosure comprises or consists essentially of (i) a membrane electrode assembly (MEA) comprising an anode, a cathode, and an AEM; and (ii) two polar plates to conduct both electric current and electrolytes.

Disclosed herein is a method for production of high grade water comprising dissolving an amount of a solubilizing anion in low grade water having one or more cations under conditions suitable to form a suspension with insoluble complexes of the solubilizing anion and cation; and separating the insoluble complexes from to obtain a higher grade water. In one or more aspects, an alkaline electrolyte can be prepared from the higher grade water by introducing an alkaline agent to the higher grade water. In an aspect, the alkaline electrolyte comprises potassium hydroxide and is used in an AEM electrolyzer. The AEM water electrolyzer may be have voltages at 1 A/cm² and 65° C. are approximately 1.800 V with 1 M KOH and high grade water and 1.891 V with 1 M KOH and tap water. In one or more aspects, the AEM water electrolyzer may have performance degradation rate ranging from about 0.1 mV/h to about 2.0 mV/h, alternatively from about 0.3 mV/h and to about 1.58 mV/h, and from about 0.5 mV/h to about 1.5 mV/h when compared with the performance rate observed with high grade water compared to untreated tap water electrolytes.

In one or more aspects, a method of the present disclosure comprises dissolving an amount of PO₄³⁻ in sea water to form a suspension with Ca₃(PO₄)₂ and Mg₃(PO₄)₂; separating the Ca₃(PO₄)₂ and Mg₃(PO₄)₂ from suspension by centrifugation, gravity or filtration to obtain a clear solution; dissolving an amount of C₂O₄²⁻ in PO₄³⁻ treated sea water to form a suspension; separating the CaC₂O₄ and MgC₂O₄ from suspension by filtration to obtain a clear solution; utilizing the treated sea water to prepare KOH electrolyte; and employing the KOH+treated sea water as the electrolytes for water electrolyzer.

Also disclosed herein is a method comprising dissolving an amount of PO₄³⁻ in sea water to form a suspension with Ca₃(PO₄)₂ and Mg₃(PO₄)₂; separating the Ca₃(PO₄)₂ and Mg₃(PO₄)₂ from suspension by centrifugation, gravity or filtration to obtain a clear solution; dissolving an amount of C₂O₄²⁻ in PO₄³⁻ treated sea water to form a suspension; separating the CaC₂O₄ and MgC₂O₄ from suspension by filtration to obtain a clear solution; utilizing the treated sea water to prepare KOH electrolyte; and employing the KOH and treated sea water as the electrolytes for water electrolyzer.

In one or more aspects, the anionic salts comprise K₂C₂O₄ and (NH₄)₂C₂O₄ which may be dissolved at 13x of KsPO₄ and 0.1×g of K₂C₂O₄ or (NH₄)₂C₂O₄, respectively, in x L of tap water where x ranges from about 0.1 g to about 10 g. In alternative aspects, the anionic salts comprise K₂C₂O₄ and (NH₄)₂C₂O₄ which may be dissolved at 0.4× and 0.3×g of K₂C₂O₄ and (NH₄)₂C₂O₄, respectively, in x L of tap water where x ranges from about 0.1 g to about 10 g.

The methods and compositions disclosed herein beneficially allow for the rapid production of a WARM which is suitable for use in an electrolyzer. In one or more aspects, the WARM has a reduction in the metal content of from about 50% to about 100%, alternatively greater than about 75%, alternatively greater than about 80%, alternatively greater than about 90% or alternatively greater than about 95%.

### EXAMPLES

The aspects having been generally described, the following example is given as particular aspects of the disclosure and to demonstrate the practice and advantages thereof. It is understood that the example is given by way of illustration and is not intended to limit the specification or the claims in any manner.

Tap water treatment with K₂C₂O₄ or (NH₄)₂C₂O₄ and sea water treatment with K₃PO₄ and K₂C₂O₄.

Chemicals: Potassium oxalate monohydrate (K₂C₂O₄·H₂O, ≥99%, Sigma-Aldrich), ammonium oxalate monohydrate ((NH₄)₂C₂O₄·H₂O, ≥99%, Sigma-Aldrich), potassium phosphate tribasic (K₃PO₄, ≥98%, Sigma-Aldrich), potassium hydroxide (KOH, 85%, Arcos Organics), iron (III) nitrate nonahydrate (Fe(NO₃)₃·9H₂O, 98.0-101.0%, Alfa Aesar), nickel (II) nitrate hexahydrate (Ni(NO₃)₂·6H₂O, ≥97%, Sigma-Aldrich), ammonium molybdate tetrahydrate ((NH₄)₆Mo₇O₂₄·4H₂O, 81.0-83.0% MoO₃ basis, Sigma-Aldrich), ammonium fluoride (NH₄F, 96%, Alfa Aesar), urea (Promega Corporation), ethanol (C₂H₅OH, Decon Labs, Inc.), and hydrochloric acid (HCl, 36.5-38.0% w/w, Fisher Chemical) were used without further purification. Filter paper (qualitative, 413) from VWR™ were employed for electrolyte filtration. Ni foam (thickness: 1.6 mm, porosity: ~95%) pieces were applied as substrates. The area of all electrodes are about 25 cm². Sustainion X37-50 grade 60 Membrane from Dioxide Materials™ was employed as the anion exchange membrane (AEM) for the AEM water electrolyzer. Tap water was obtained from Houston Science Center, University of Houston and used for all of the aqueous solutions. Seawater was collected from Galveston Bay, Galveston, Texas, USA (29.303° N, 94.772° W). Deionized (DI) water was utilized for the catalyst preparation.

Preparation of KOH electrolytes with untreated tap water. Different amounts of KOH pellet were dissolved in tap water obtained from Houston Science Center University of Houston, to prepare 1, 2, 3, 4, 5, 6 mole/L KOH electrolytes. The KOH electrolytes were then transfer into small transparent glass vials with the volume of ~25 mL for further observation.

Ca²⁺ removal by K₂C₂O₄. 0.4 g of K₂C₂O₄·H₂O was dissolved in 1 L tap water and the solution was ultrasonicated for 1 min to accelerate the complete dissolution. After the tap water and K₂C₂O₄ suspension was prepared, filtration via filter paper was employed to separate the CaC₂O₄ from the solution then the majority of Ca²⁺ was removed from tap water.

Preparation of KOH electrolytes with K₂C₂O₄ treated tap water. Different amounts of KOH pellets were dissolved in the K₂C₂O₄ treated tap water to prepare 1, 2, 3, 4, 5, 6 mole/L KOH electrolytes. The KOH+K₂C₂O₄ treated tap water electrolytes were then transfer into small transparent glass vials with the volume of ~25 mL for further observation.

Ca²⁺ removal by (NH₄)₂C₂O₄. 0.3 g of (NH₄)₂C₂O₄·H₂O was dissolved in 1 L tap water and the solution was ultrasonicated for 1 min to accelerate the complete dissolution. After the tap water and (NH₄)₂C₂O₄ suspension was prepared, filtration via filter paper was employed to separate the CaC₂O₄ from the solution then the majority of Ca²⁺ was removed from tap water.

Preparation of KOH electrolytes with (NH₄)₂C₂O₄ treated tap water. Different amounts of KOH pellets were dissolved in the (NH₄)₂C₂O₄ treated tap water to prepare 1, 2, 3, 4, 5, 6 mole/L KOH electrolytes. The KOH and (NH₄)₂C₂O₄ treated tap water electrolytes were then transfer into small transparent glass vials with the volume of ~25 mL for further observation.

Ca²⁺ and Mg²⁺ removal by K₃PO₄ and K₂C₂O₄. 13 g of K₃PO₄ was dissolved in 1 L seawater and the white suspension was prepared. The majority of Ca₃(PO₄)₂ and Mg₃(PO₄)₂ in suspension was removed by centrifugation or gravity. Then the remaining precipitates were completely removed by filtration. After, 0.1 g of K₂C₂O₄·H₂O was dissolved in 1 L K₃PO₄ treated sea water and the solution was ultrasonicated for 1 min to accelerate the complete dissolution. Then the suspension was filtered via filter paper to separate the CaC₂O₄ then the remaining Ca²⁺ was removed from K₃PO₄ treated sea water. The obtained K₃PO₄ and K₂C₂O₄ treated seawater was employed to prepared the KOH electrolytes.

Preparation of KOH electrolytes with K₃PO₄ and K₂C₂O₄ treated sea water. Different amounts of KOH pellets were dissolved in the K₃PO₄ and K₂C₂O₄ treated sea water to prepare 1, 2, 3, 4, 5, 6 mole/L KOH electrolytes. The KOH and K₃PO₄ and K₂C₂O₄ treated sea water electrolytes were then transfer into small transparent glass vials with the volume of ~25 mL for further observation.

Preparation of NiMo nitride (NIMoN) on the surface of nickel foam. NF was rinsed by 3 M HCl, ethanol and DI water for 3 min respectively to clean the surface oxide and organic impurity. A precursor of 50 mL 0.01 M (NH₄)₆Mo₇O₂₄·4H₂O and 0.04 M Ni(NO₃)₂·6H₂O was prepared and transferred into a 100 mL autoclave. A cleaned NF with the size of 2×5 cm² was transferred into the autoclave. Then the autoclave was placed in a drying oven and maintained at 150° C. for 6 h. After the hydrothermal process, the synthesized NiMoO₄/NF was rinsed with DI water for several times then dried at ambient condition overnight. The nitradition of NiMoO₄/NF was conducted in a tube furnace under 400° C. for 2 h with a gas flow of 30 standard cubic centimeters (sccm) Ar and 120 sccm NH₃. After the nitridation process, the HER active NiMoN/NF was prepared and applied as the cathode for the AEM electrolyzer.

Preparation of NiFe layered double hydroxides (LDH) on the surface of nickel foam. A 50 mL solution of 0.01 M Fe(NO₃)₃·9H₂O, 0.01 M Ni(NO₃)₂·6H₂O, 0.06 M urea and 0.075 M NH₄F was prepared and transferred into the 100 mL autoclave. A piece of 2×5 cm² cleaned NF was transferred into the autoclave for further hydrothermal process. The hydrothermal process was conducted in an oven at 150° C. for 6 h. After, the NiFe LDH/NF was washed with DI water for several time and dried at ambient condition overnight for further utilization as the anode in AEM electrolyzer.

Material characterization. Scanning electron microscopy (SEM) and energy-dispersive spectroscopy (EDS) were conducted using a LEO 1525 SEM.

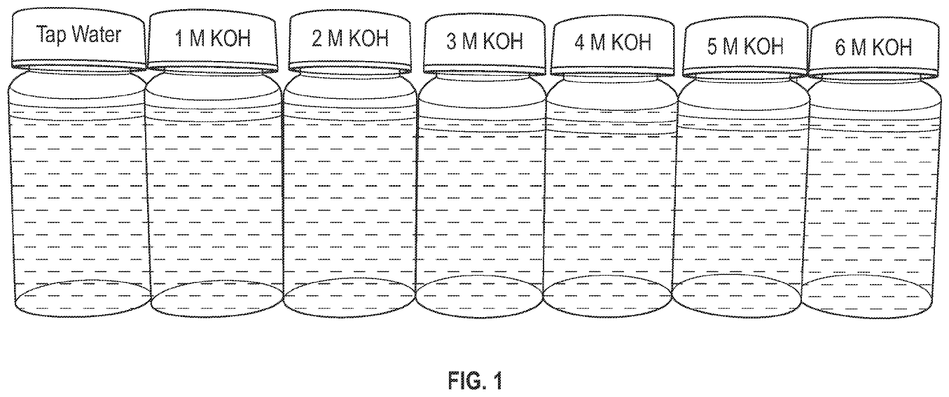

The prepared KOH electrolytes with untreated tap water were suspensions with white precipitates as displayed in FIG. 1. FIG. 1 shows an exemplary image of KOH+tap water electrolytes with different concentrations. The KOH and tap water electrolytes from 1 mole/L to 6 mole/L, with the interval of 1 mole/L, are given in the picture. The aspects show the KOH electrolytes prepared with untreated tap water are white suspension and the one with higher KOH concentration, the suspension becomes more turbid. The suspension feature of KOH and tap water electrolytes is caused by the formation of Ca(OH)₂ suspensions in electrolytes. The aspects show the prepared KOH and tap water electrolytes herein are not suitable for direct usage of water electrolysis.

In summary, the Ca²⁺ ions in tap water combined with OH″ ions and generated the insoluble Ca(OH)₂. In water electrolysis, the insoluble Ca(OH)₂ will deposit on the surface of cathode and block the active sites of HER catalysts, which is detrimental to the activity and stability of catalysts. Therefore, further treatment is required to remove the Ca²⁺ ions in tap water to make it viable for active and long-term water electrolysis.

The Kₛₚ of CaC₂O₄ is 2.32×10⁻⁹, which is much smaller than the 5.02×10⁻⁶ of Ca(OH)₂. The smaller Kₛₚ value of CaC₂O₄ means the Ca²⁺ has higher ability to bind with C₂O₄²⁻ to form the insoluble CaC₂O₄ than OH⁻ to form the insoluble Ca(OH)₂. Therefore, dissolving oxalate salts such as K₂C₂O₄ or (NH₄)₂C₂O₄ into the tap water will be a quick and cheap strategy to remove Ca²⁺ from tap water then prepare it for the efficient and stable water electrolysis.

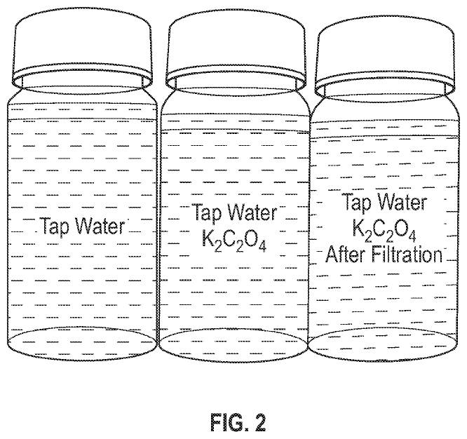

In FIG. 2, the tap water with K₂C₂O₄ dissolved was a turbid solution with white precipitates dispersed evenly. FIG. 2 shows an exemplary image of tap water, tap water with K₂C₂O₄, and tap water with K₂C₂O₄ after filtration. Dissolving K₂C₂O₄ can effectively eliminate the Ca²⁺ from tap water as CaC₂O₄ precipitates. In aspects, for example, dissolving 0.4×g K₂C₂O₄·H₂O in x L tap water is able to remove the majority of the Ca²⁺. Higher amount of K₂C₂O₄·H₂O is acceptable but not encouraged since it only causes a waste of material. Tap water with K₂C₂O₄ is a suspension as illustrated in this aspect. After filtration by the filter paper (grade 413, particle retention 5 μm), the CaC₂O₄ is separated from tap water and the K₂C₂O₄ treated tap water becomes clear again. The formation of white precipitates was contributed by the generation of insoluble CaC₂O₄. Subsequently, the insoluble CaC₂O₄ was separated from the tap water by a simple filtration via a filter paper. After the filtration, the tap water suspension became clear solution again, which indicated the majority of Ca²⁺ was eliminated from tap water. Subsequently, the K₂C₂O₄ treated tap water was utilized to prepare the KOH electrolyte with different concentrations. In summary, this aspect shows K₂C₂O₄ can be utilized to remove the Ca²⁺ in tap water and after separating the CaC₂O₄, the treated tap water is ready for the preparation of KOH electrolytes and water electrolysis.

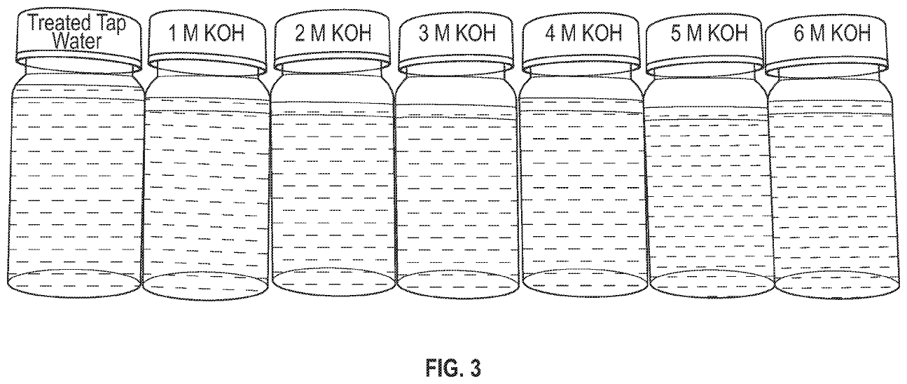

FIG. 3 shows an exemplary image of different KOH electrolytes prepared with K₂C₂O₄ treated tap water. In aspects, the KOH electrolytes from 1 to 6 mole/L (interval of 1 mole/L) prepared with the K₂C₂O₄ treated tap water described in FIG. 2 are presented. In aspects, the KOH electrolytes herein show no precipitate, which is different from the KOH suspension presented in FIG. 1 thereon. The aspects hereon prove the K₂C₂O₄ treated tap water is suitable for the preparation of KOH electrolytes for water electrolysis.

As shown in FIG. 3, no precipitate can be observed in all KOH electrolytes from 1 to 6 M prepared with K₂C₂O₄ treated tap water, thus indicating very little or even close to zero amount of Ca(OH)₂ generated in these electrolytes. The FIG. 2 and FIG. 3 proved the majority of Ca²⁺ can be removed by dissolving an appropriate amount of K₂C₂O₄ in tap water and filtering the CaC₂O₄ out of the solution. Then the K₂C₂O₄ treated tap water is ready for active and stable water electrolysis.

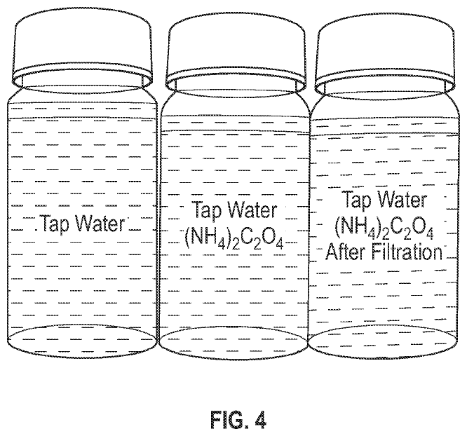

(NH₄)₂C₂O₄ was then employed to verify the versatility of this principle. In FIG. 4, dissolving (NH₄)₂C₂O₄ in tap water created a suspension similar to the tap water with K₂C₂O₄ in FIG. 2, which suggested the formation of CaC₂O₄ in the solution. FIG. 4 shows an exemplary image of tap water, tap water with (NH₄)₂C₂O₄, and tap water with (NH₄)₂C₂O₄ after filtration. Similar to the aspects in FIG. 2, the aspects herein show the tap water with (NH₄)₂C₂O₄ is a suspension due to the formation of CaC₂O₄, and after filtration by a filter paper (qualitative, 413), the (NH₄)₂C₂O₄ treated tap water becomes clear again. In aspects, the Ca²⁺ can be effectively removed by dissolving 0.3×g (NH₄)₂C₂O₄·H₂O in x L tap water then separating CaC₂O₄ via filter paper. The aspects herein suggest the (NH₄)₂C₂O₄ treated tap water for the preparation of KOH electrolytes for water electrolysis. In summary, after a simple filtration, most of the CaC₂O₄ was separated from the tap water with (NH₄)₂C₂O₄ and became clear again.

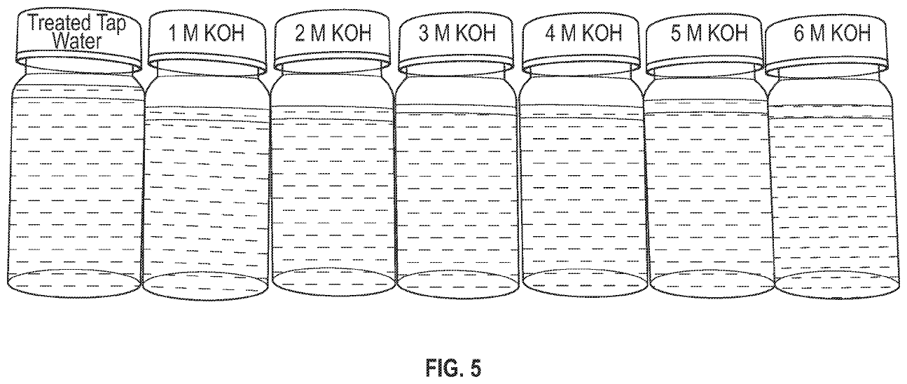

FIG. 5 shows an exemplary image of different KOH electrolytes prepared with (NH₄)₂C₂O₄ treated tap water. In aspects, the KOH electrolytes herein from 1 to 6 mole/L (interval of 1 mole/L) prepared with the (NH₄)₂C₂O₄ treated tap water display clear feature, which are similar to the clear KOH electrolytes shown in FIG. 3 and different from the turbid KOH electrolytes in FIG. 1 thereon. Different concentration KOH electrolytes from 1 to 6 M were then prepared with the (NH₄)₂C₂O₄ treated tap water. As displayed in FIG. 5, the KOH electrolytes were clear solutions similar to the KOH electrolytes presented in FIG. 3. The above results showed the (NH₄)₂C₂O₄ is another appropriate oxalate salt to remove Ca²⁺ and the (NH₄)₂C₂O₄ treated tap water is ready for the utilization of active and stable water electrolysis. The aspects hereon prove the KOH electrolytes treated with (NH₄)₂C₂O₄ are suitable for the water electrolysis.

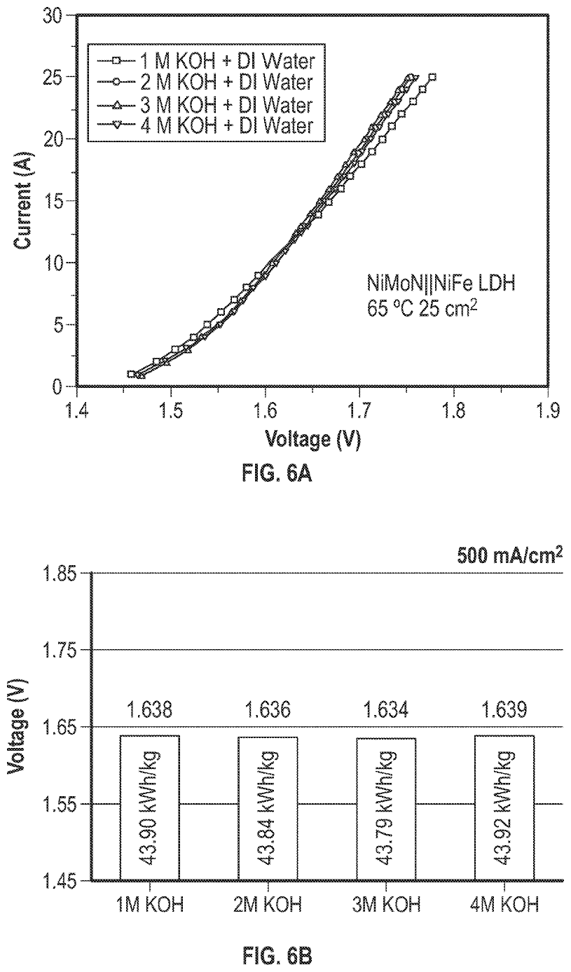

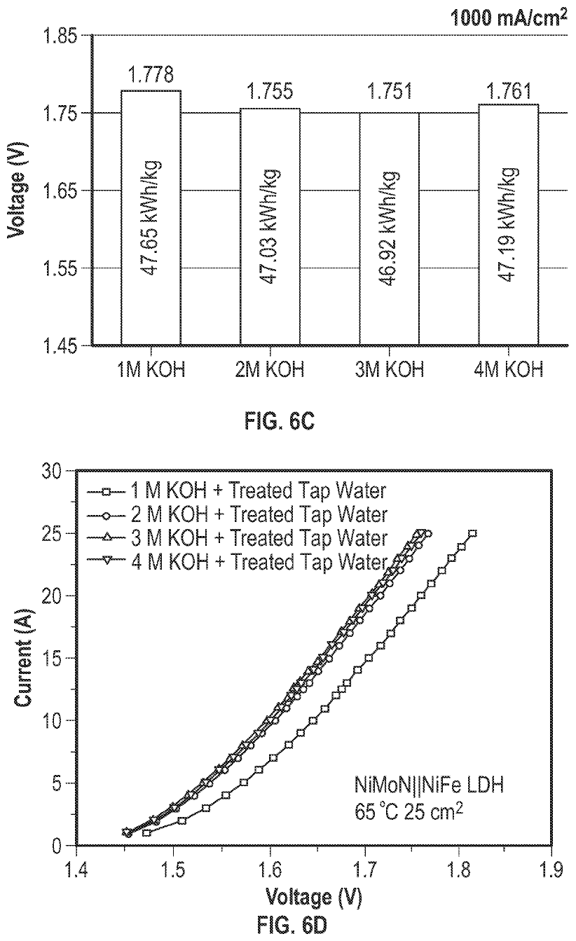

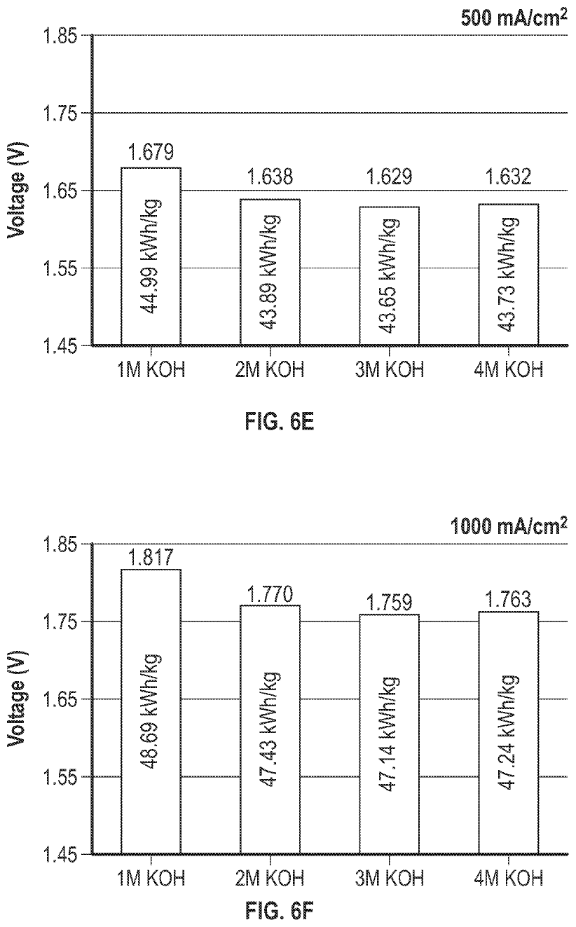

Results in FIG. 6 shows the cell performances of treated tap water are close to the performances in DI water. NiMoN and NiFe LDH were grown on the surface of NF as cathode and anode for alkaline water electrolysis, respectively. The electrolyzer was first measured in the KOH electrolytes prepared with DI water and the I-V curves are presented in FIG. 6a. The voltages and corresponding energy consumption required to deliver 500 and 1000 mA/cm² are given in FIG. 6b and FIG. 6c, respectively. Then tap water treated with K₂C₂O₄ was employed to prepare the different KOH electrolytes. FIG. 6d shows the I-V curves of the electrolyzer in the KOH electrolytes prepared with treated tap water. The voltages and corresponding energy consumption required to deliver 500 and 1000 mA/cm² are given in FIG. 6e and FIG. 6f, respectively.

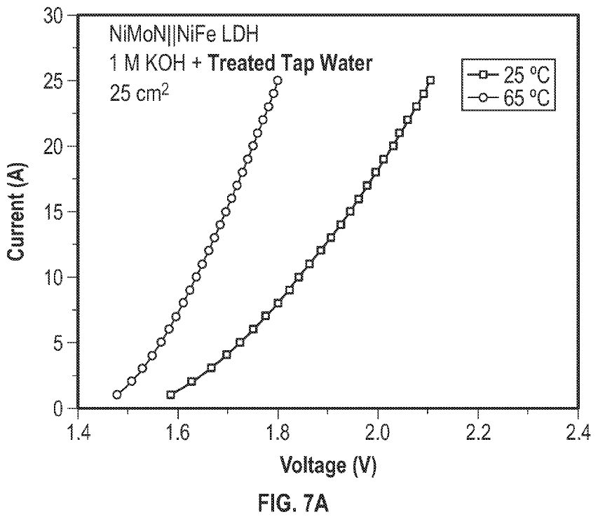

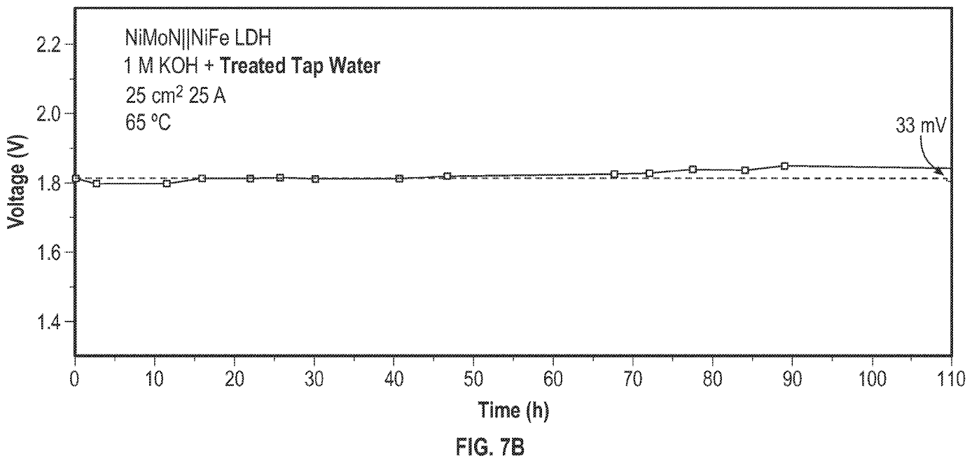

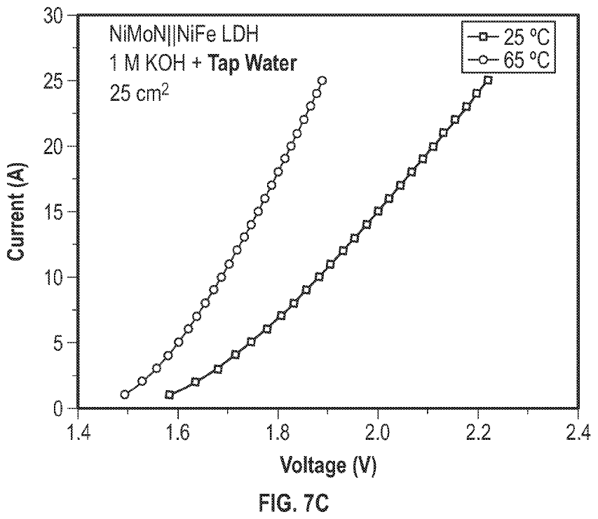

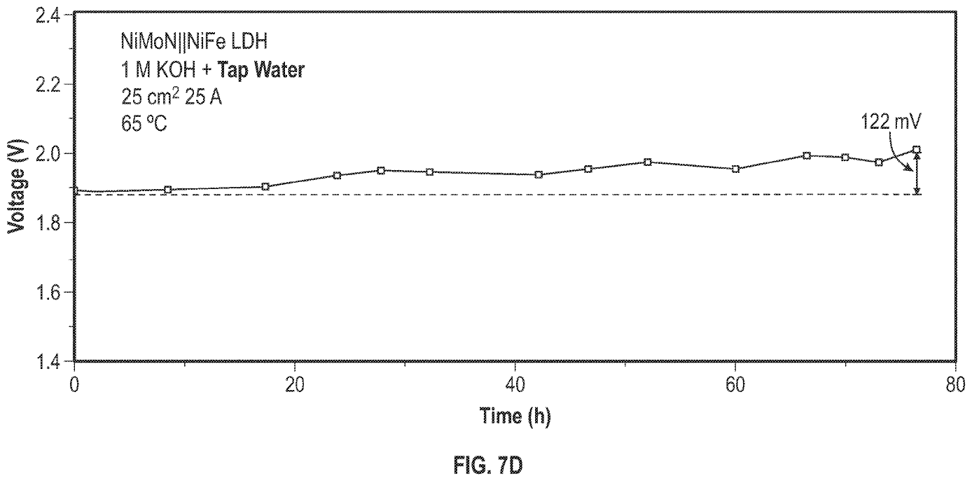

FIG. 7a shows the I-V polarization data of NiMoN∥NiFe LDH AEM electrolyzer at 25 and 65° C. in the 1 M KOH and treated tap water. Specifically, the AEM electrolyzer delivered 1 A/cm² at 1.800 V at 65° C. in the 1 M KOH and treated tap water. FIG. 7b presents the chronopotentiometric test of the electrolyzer working with the 1 M KOH and treated tap water at 1 A/cm² and 65° C. After a 110 h continuous test, the working voltage increased by 33 mV, showing an increasing rate of 0.3 mV/h. The untreated tap water was then utilized to prepare 1 M KOH electrolyte. The same AEM electrolyzer was employed and the water electrolysis performances at 25 and 65° C. in the 1 M KOH and tap water were given in FIG. 7c. At 1 A/cm² and 65° C., the required voltage was 1.891 V, which was higher than the 1.800 V in 1 M KOH and treated tap water. Furthermore, the untreated tap water was added into the electrolytes to compensate the water consumed during the long-term chronopotentiometric test. In FIG. 7d, the AEM electrolyzer in 1 M KOH and tap water displayed a 122 mV increase during a 77 h continuous test, showing an increasing rate of 1.58 mV/h. From the data in FIG. 7, the 1 M KOH electrolyte prepared with treated tap water is more benign to the electrolyzer in aspects of activity and stability.

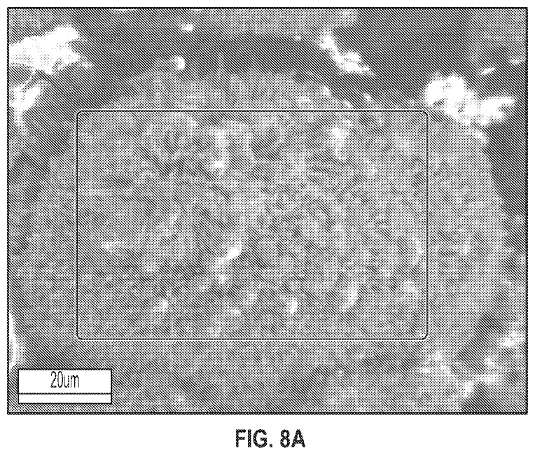

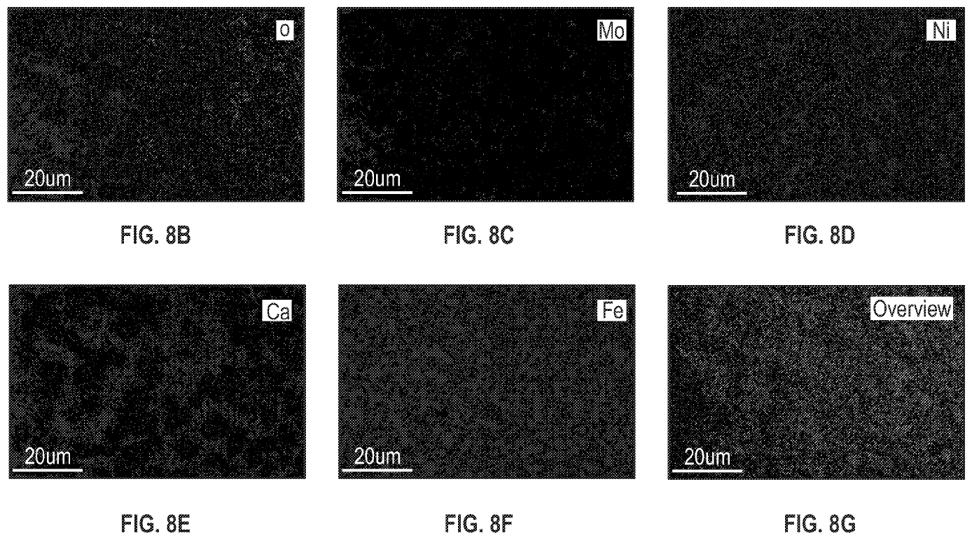

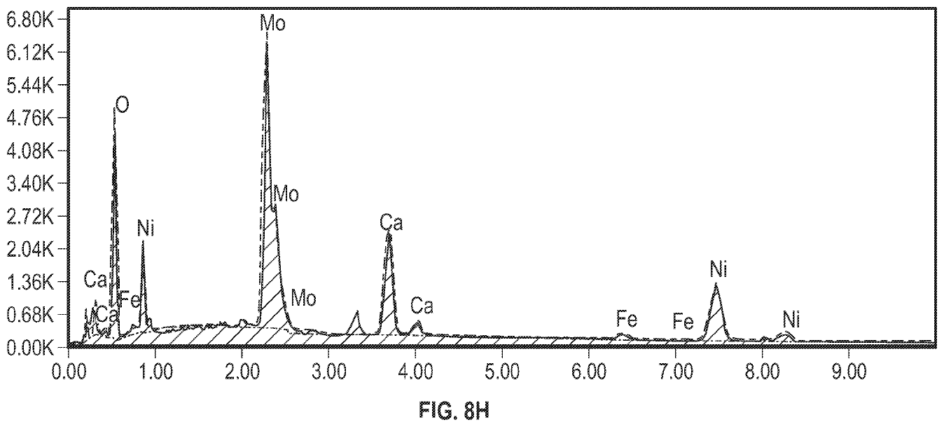

Further analyses were conducted to study the quick degradation of the AEM electrolyzer in 1 M KOH and tap water. FIG. 8a presented the SEM image of NiMON after stability test in 1 M KOH+tap water and many micro-particles can be observed on the surface of NiMON micro-rods. FIG. 8b-8g showed the EDS mapping the rectangle area of FIG. 8a, and except the Ni and Mo elements from NiMoN, large amounts of Ca and O element were discovered in the area with micro-particles precipitates. The small amount of Fe was from the anode since NiFe LDH was employed as OER catalyst. FIG. 8h shows the atomic ratio of Ca in the mapping area was 12.63%. Table 2 provides the results of energy dispersive spectroscopic analysis for the samples.

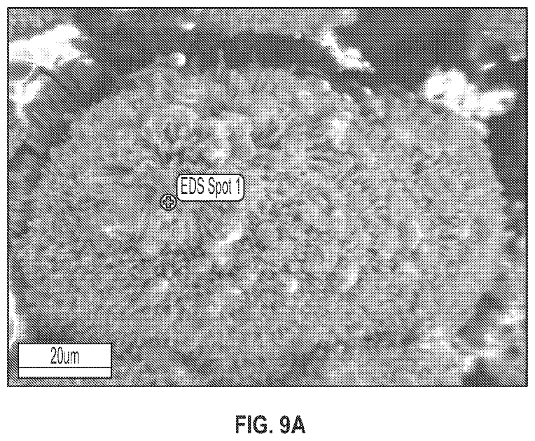

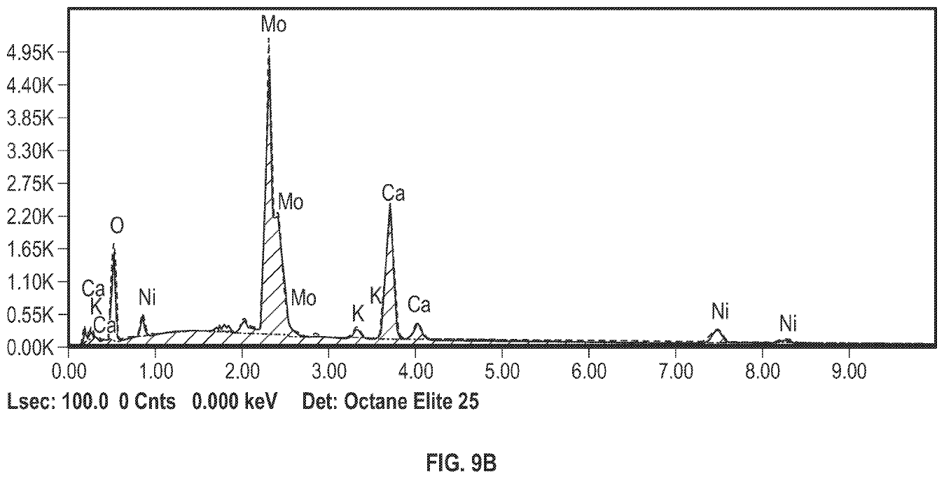

To further confirm that the precipitate was Ca(OH)₂, SEM EDS point analysis was conducted on different sites of the catalyst. In FIGS. 9a and 9b, the point analysis showed the atomic ratio of Ca was 23.76% on a precipitate, which was higher than the average of 12.63%. The results of energy dispersive spectroscopic analysis are presented in Table 3.

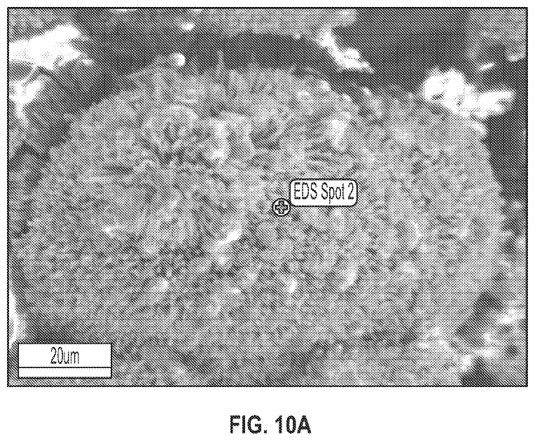

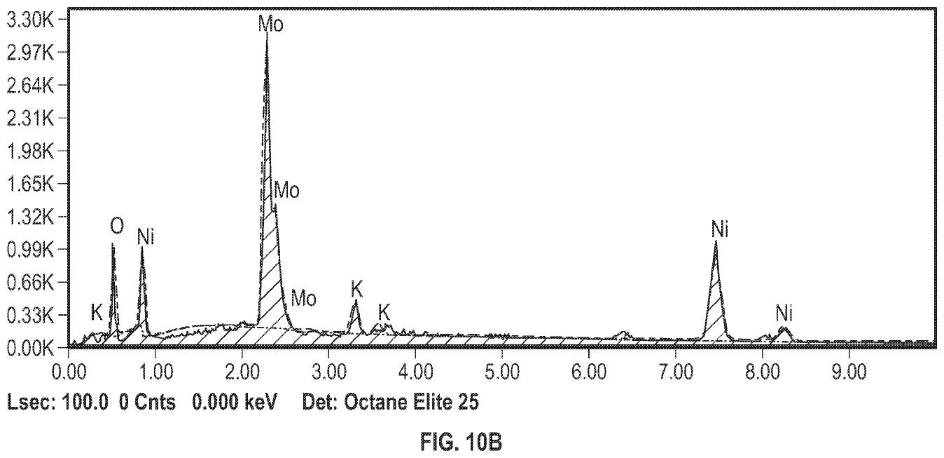

In FIGS. 10a and 10b, no Ca can be observed in the area without precipitate. The results of energy dispersive spectroscopic analysis are presented in Table 4.

TABLE 2

| Element | Wt. % | Atomic % | Net. Int. | Error % | Kratio | Z | A | F |
|---|---|---|---|---|---|---|---|---|
| OK | 21.72 | 52.77 | 131.7 | 10.12 | 0.0548 | 1.2394 | 0.2034 | 1.0000 |
| MoL | 33.69 | 13.65 | 300.80 | 2.32 | 0.2757 | 0.8456 | 0.9670 | 1.0008 |
| CaK | 13.02 | 12.63 | 132.90 | 3.98 | 0.1244 | 1.0679 | 0.8863 | 1.0098 |
| FeK | 1.80 | 1.25 | 8.80 | 14.74 | 0.0182 | 0.9547 | 0.9761 | 1.0822 |
| NiK | 29.77 | 19.71 | 94.70 | 4.26 | 0.2903 | 0.9638 | 0.9869 | 1.0254 |

TABLE 3

| Element | Wt. % | Atomic % | Net. Int. | Error % | Kratio | Z | A | F |
|---|---|---|---|---|---|---|---|---|
| OK | 19.00 | 48.24 | 83.27 | 11.38 | 0.0341 | 1.2533 | 0.1432 | 1.0000 |
| MoL | 46.09 | 19.52 | 443.19 | 2.23 | 0.4000 | 0.8556 | 1.0123 | 1.0017 |
| KK | 1.58 | 1.64 | 18.66 | 15.09 | 0.0140 | 1.0609 | 0.8223 | 1.0129 |
| CaK | 23.41 | 23.76 | 238.62 | 4.00 | 0.2200 | 1.0809 | 0.8637 | 1.0052 |
| NiK | 9.88 | 6.84 | 32.69 | 7.77 | 0.0987 | 0.9773 | 0.9801 | 1.0432 |

TABLE 4

| Element | Wt. % | Atomic % | Net. Int. | Error % | Kratio | Z | A | F |
|---|---|---|---|---|---|---|---|---|
| OK | 8.21 | 27.66 | 47.09 | 11.61 | 0.0240 | 1.3061 | 0.2234 | 1.0000 |
| MoL | 37.69 | 21.18 | 275.19 | 3.20 | 0.3086 | 0.8929 | 0.9169 | 1.0002 |
| KK | 3.22 | 4.44 | 31.47 | 8.11 | 0.0293 | 1.1080 | 0.8149 | 1.0081 |
| NiK | 50.88 | 46.72 | 140.08 | 4.33 | 0.5251 | 1.0272 | 0.9882 | 1.0177 |

Therefore, the SEM EDS analysis herein proved the Ca²⁺ precipitated on the surface of NiMON as Ca(OH)₂ when the untreated tap water was employed to prepare KOH electrolyte and added into the electrolyte to compensate the consumed water.

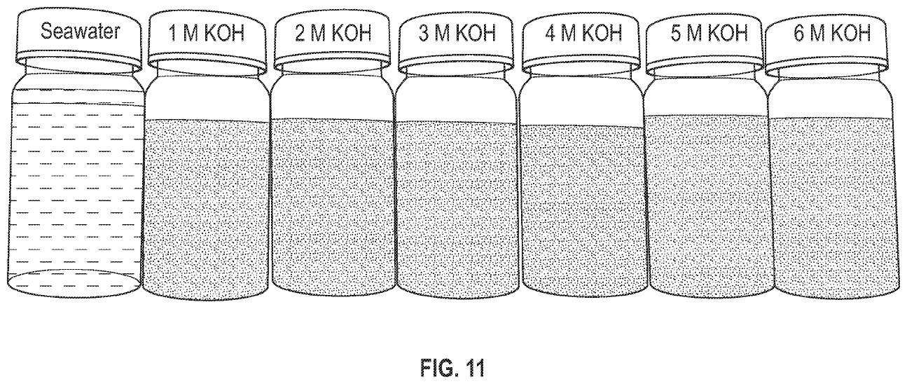

The prepared KOH electrolytes with untreated sea water were suspensions with white precipitates as displayed in FIG. 11. The Ca²⁺ and Mg²⁺ ions in sea water combined with OH-ions and generated the insoluble Ca(OH)₂ and Mg(OH)₂. In water electrolysis, the insoluble Ca(OH)₂ and Mg(OH)₂ will deposit on the surface of electrodes and block the active sites of catalysts, which is detrimental to the activity and stability of catalysts. FIG. 11 shows an exemplary image of KOH and sea water electrolytes with different concentrations. The KOH and sea water electrolytes from 1 mole/L to 6 mole/L, with the interval of 1 mole/L, are given in the picture. The aspects show the KOH electrolytes prepared with untreated sea water are white suspension. The suspension feature of KOH+sea water electrolytes is caused by the formation of Ca(OH)₂ and Mg(OH)₂ and possibly Al(OH)₃ suspensions in electrolytes. The aspects show the prepared KOH+sea water electrolytes herein are not suitable for direct usage of water electrolysis. In summary, further treatment is required to remove the Ca²⁺ ions in tap water to make it viable for active and long-term water electrolysis.

The solubility product constants (Kₛₚ) of Ca₃(PO₄)₂, Mg₃(PO₄)₂, and CaC₂O₄ are 2.07×10⁻³³, 1.04×10⁻²⁴ and 2.32×10⁻⁹, which are much smaller than the 5.02×10⁻⁶ and 5.61×10⁻¹² of Ca(OH)₂ and Mg(OH)₂, respectively. The smaller Kₛₚ values of Ca₃(PO₄)₂, Mg₃(PO₄)₂, and CaC₂O₄ mean the Ca²⁺ and Mg²⁺ have higher ability to bind with PO₄³⁻ and C₂O₄²⁻ to form insoluble Ca₃(PO₄)₂, Mg₃(PO₄)₂, and CaC₂O₄ than with OH⁻ to form the insoluble Ca(OH)₂ and Mg(OH)₂. Therefore, dissolving phosphate and oxalate salts such as K₃PO₄ and K₂C₂O₄ or (NH₄)₂C₂O₄ into sea water will be a quick and cheap strategy to remove Ca²⁺ and Mg²⁺ from sea water then prepare it for the efficient and stable water electrolysis.

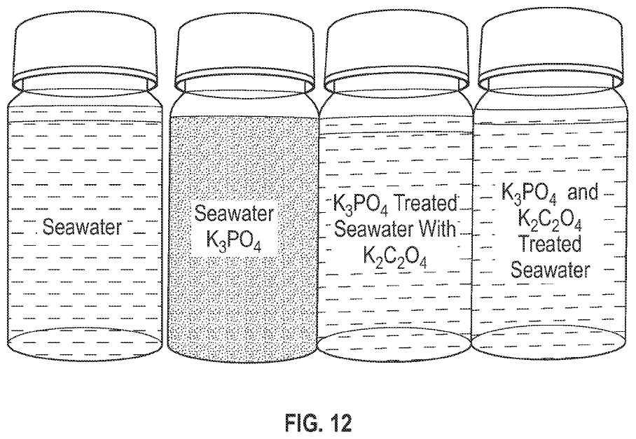

In FIG. 12, the sea water with K₃PO₄ dissolved was a turbid suspension with white precipitates dispersed evenly. FIG. 12 shows an exemplary image of sea water, sea water with K₃PO₄, K₃PO₄ treated sea water with K₂C₂O₄, K₃PO₄ and K₂C₂O₄ treated sea water after filtration. Dissolving K₃PO₄ and K₂C₂O₄ can effectively eliminate the Ca²⁺ and Mg²⁺ from sea water as Ca₃(PO₄)₂, Mg₃(PO₄)₂ and CaC₂O₄ precipitates. In aspects, for example, dissolving 13×g KsPO₄ and 0.1×g K₂C₂O₄·H₂O in x L sea water is able to remove the majority of the Ca²⁺ and Mg²⁺. Higher amount of K₃PO₄ and K₂C₂O₄·H₂O is applicable due to the changing amount of Ca²⁺ and Mg²⁺ in seawater from area to area and time to time. Sea water with K₃PO₄ and K₂C₂O₄ is a suspension as illustrated in this aspect. After filtration, the Ca₃(PO₄)₂, Mg₃(PO₄)₂, and CaC₂O₄ are separated from sea water then the K₃PO₄ and K₂C₂O₄ treated sea water becomes clear again. In summary, this aspect shows K₃PO₄ and K₂C₂O₄ can be utilized to remove the Ca²⁺ in sea water and after separating Ca₃(PO₄)₂, Mg₃(PO₄)₂, and CaC₂O₄, sea water is ready for the preparation of KOH electrolytes and water electrolysis. The white precipitates mainly consisted of the insoluble Ca₃(PO₄)₂ and Mg₃(PO₄)₂. Subsequently, the precipitates were separated from sea water by centrifugation or gravity. Then the sea water solution was filtered by filter paper to remove the remaining precipitates and the K₃PO₄ treated sea water was obtained. Subsequently, K₂C₂O₄ was dissolved in K₃PO₄ treated sea water and the seawater became turbid again due to the formation of CaC₂O₄ and MgC₂O₄. The solution was filtered with filter paper to remove CaC₂O₄ and MgC₂O₄ then the KsPO₄ and K₂C₂O₄ treated seawater was obtained and used for further preparation of KOH electrolytes.

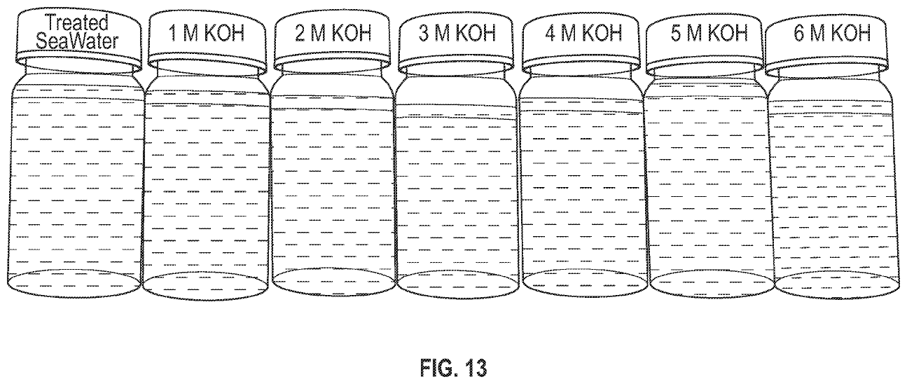

FIG. 13 shows an exemplary image of different KOH electrolyte prepared with K₃PO₄ and K₂C₂O₄ treated sea water. In aspects, the KOH electrolytes from 1 to 6 mole/L (interval of 1 mole/L) prepared with K₃PO₄ and K₂C₂O₄ treated sea water described in FIG. 12 are presented. In aspects, the KOH electrolytes herein show no precipitate from 1 to 5 mole/L, which is different from the KOH suspension presented in FIG. 11 thereon. Besides, the 6 mole/L KOH electrolyte shows a small amount of precipitates. The aspects hereon prove the K₃PO₄ and K₂C₂O₄ treated sea water is suitable for the preparation of KOH electrolytes for water electrolysis. As shown in FIG. 13, no precipitate can be observed in the KOH electrolytes from 1 to 5 M prepared with K₃PO₄ and K₂C₂O₄ treated sea water, thus indicating very little or even close to zero amount of Ca(OH)₂ and Mg(OH)₂ generated in these electrolytes. In the 6 M KOH electrolyte prepared with K₃PO₄ and K₂C₂O₄ treated sea water, a small amount of white precipitates can be observed. The FIG. 12 and FIG. 13 proved the majority of Ca²⁺ and Mg²⁺ can be removed by the dissolution of an appropriate amount of K₃PO₄ and K₂C₂O₄ in sea water and the centrifugation or gravity and filtration. The K₃PO₄ and K₂C₂O₄ treated sea water is ready for active and stable water electrolysis.

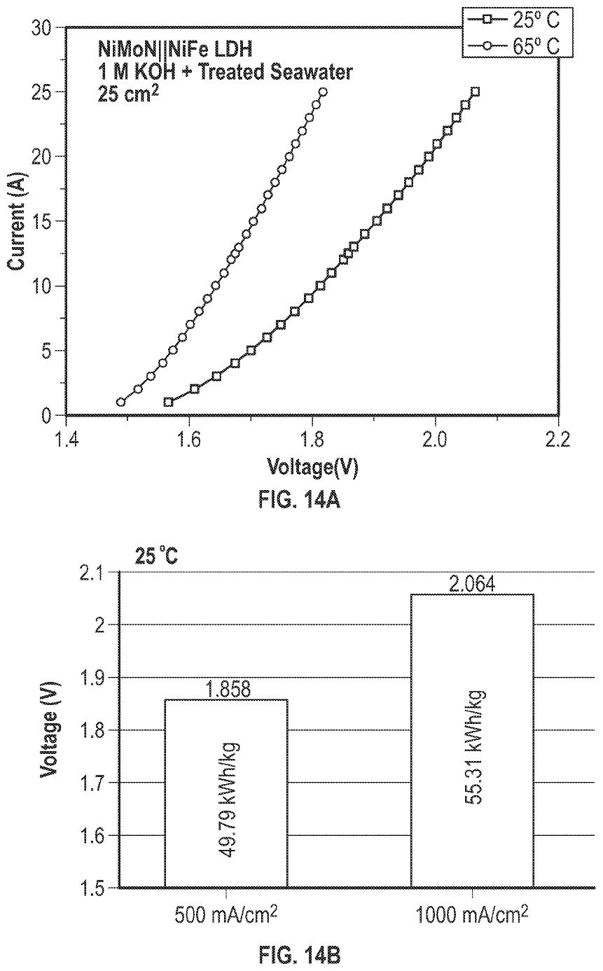

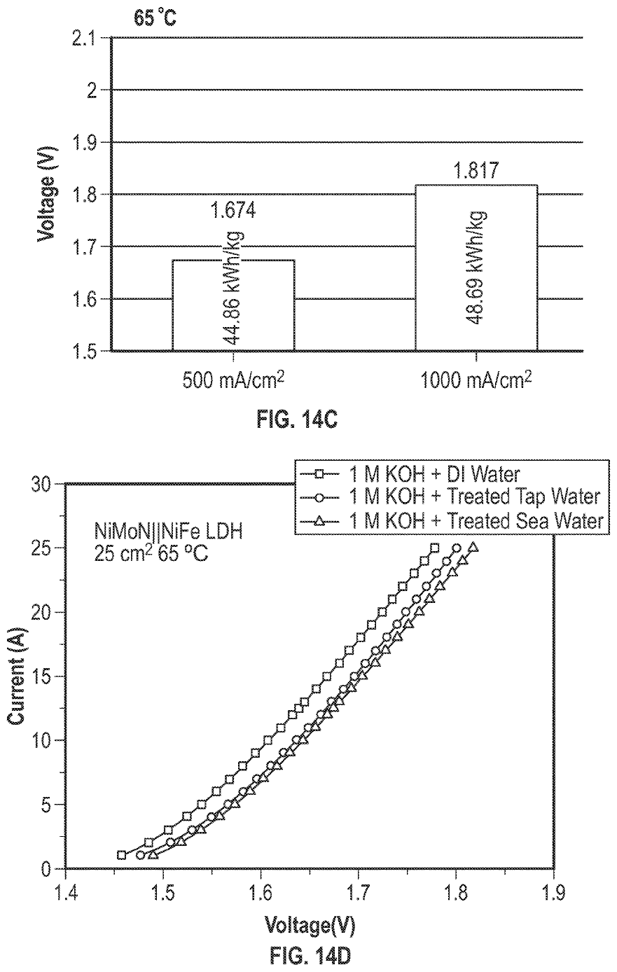

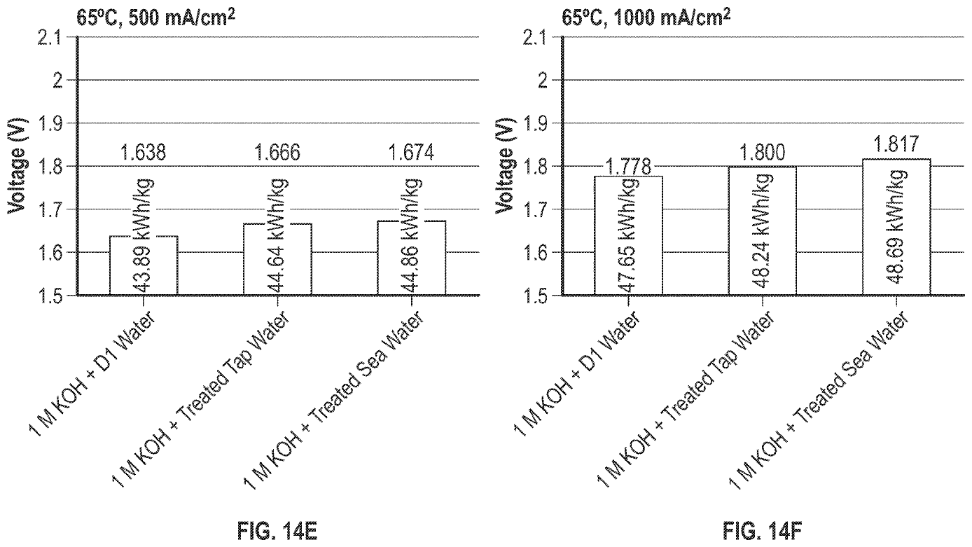

Results in FIG. 14 shows the cell performances of treated sea water are close to the performances in DI water and treated tap water. NiMoN and NiFe LDH were grown on the surface of NF as cathode and anode for alkaline water electrolysis, respectively. The electrolyzer was first measured in 1 M KOH and treated sea water at 25 and 65° C. and the I-V curves are presented in FIG. 14a. The voltages and corresponding energy consumption required to deliver 500 and 1000 mA/cm² at 25 and 65° C. are given in FIG. 14b and FIG. 14c, respectively. Then sea water treated with K₃PO₄ and K₂C₂O₄ was employed to prepare the 1 M KOH electrolytes. FIG. 14d shows the I-V curves of the electrolyzer in the KOH electrolytes prepared with different water. The voltages and corresponding energy consumption required to deliver 500 and 1000 mA/cm² are given in FIG. 14e and FIG. 14f, respectively.

The present disclosure first reveals the formation of Ca(OH)₂, Mg(OH)₂, Al(OH)₃, etc. by preparing the KOH electrolytes with untreated tap and sea water then provides aspects to exemplify the removal of Ca²⁺, Mg²⁺, Al³⁺, etc. via dissolving oxalate and phosphate salts into tap and sea water. Finally, the water electrolysis performance of AEM electrolyzer with the treated and untreated tap water will be discussed in detail with the herein Examples to prove the advantages and necessities of the treatment.

The present disclosure relates to fast and scalable removal of Ca²⁺, Mg²⁺, Al³⁺, etc. for efficient and long-term stable low grade water electrolysis (e.g., tap water, sea water). Aspects of the present disclosure describe the fast removal of Ca²⁺, Mg²⁺, Al³⁺, etc. in tap and sea water then the preparation of different KOH concentration electrolytes using the treated tap and sea water. Aspects of the present disclosure discuss the activity and stability of the AEM electrolyte in the herein treated and untreated low grade water (e.g., tap water). Aspects of the present disclosure are applicable to but not limited to tap and sea water containing Ca²⁺, Mg²⁺, Al³⁺, etc. Compared with the traditional RO water purification, the disclosed method does not demand expensive facility or consume extra energy to obtain water suitable for electrolysis, and is thus beneficial to the process for low-cost H₂ generation from water electrolysis.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A method for reducing the metal content in a water source comprising:
dissolving an amount of a solubilizing anion in a low grade water comprising one or more cations under conditions suitable to formed a suspension comprising insoluble solubilizing anion-cation complexes wherein the anion comprises; and
separating the insoluble solubilizing anion-cation complexes from the suspension to obtain a higher grade water having a metal content reduced by from about 50% to about 100%.

2. The method of claim 1, wherein the solubilizing anion comprises oxalate, phosphate or combinations thereof.

3. The method of claim 2, wherein the oxalate salt comprises K₂C₂O₄, (NH₄)₂C₂O₄ or combinations thereof.

4. The method of claim 1, wherein the cation comprises calcium, magnesium, potassium or combinations thereof.

5. The method of claim 1, wherein separating insoluble anion-cation complexes from the suspension occurs by filtration, gravity, centrifugation or a combination thereof.

6. The method of claim 1, further comprising utilizing the higher grade water to prepare an alkaline electrolyte; and
employing the alkaline electrolyte in a water electrolyzer.

7. The method of claim 6, wherein the alkaline electrolyte comprises potassium hydroxide.

8. The method of claim 7, wherein the concentration of potassium hydroxide ranges from about 1 M to about 6 M.

9. The method of claim 6, wherein the water electrolyzer is a PEM water electrolyzer, an AEM water electrolyzer, or an alkaline water electrolyzer.

10. The method of claim 6, wherein the AEM water electrolyzer comprises a cathode, an anode and an anion exchange membrane.

11. The method of claim 9, wherein the cathode comprises a HER catalyst.

12. The method of claim 11, wherein the HER catalyst comprises noble metals; noble metal alloys; transitions metals; supported transition metals; nonmetals; nonmetal alloys or combinations thereof.

13. The method of claim 9, wherein the HER catalyst comprises Pt, Pd, Ir, Ru, Ag, Fe, Co, Ni, Mn, Cu, Mo, W, B, C, N, P, S, alloys thereof or combinations thereof.

14. The method of claim 9, wherein the HER catalyst comprises MoP, Pt/C, Pd/C, Ru/C₃N₄/C, RuO₂/Co₃O₄, Fe—CoP/Ti, and NiMoN.

15. The method of claim 9, wherein the HER catalyst comprises NiMoN.

16. The method of claim 9, wherein the anode comprises an OER catalyst.

17. A method, comprising:
contacting a first water with a solubilizing anion to form a second water comprising a suspension of an insoluble complex of the soluble anion and a cation, wherein the first water has a resistivity of less than about 18 MΩ-cm and a conductivity of less than about 0.056 μS/cm and the second water has a resistivity that is at least 50% greater than the first water and a conductivity that is at least 50% greater than the first water.

18. The method of claim 17, wherein the first water is sourced from tap water, seawater or a combination thereof.

19. The method of claim 17, wherein the solubilizing anion comprises oxalate, phosphate or combinations thereof.

20. The method of claim 17, further comprising separating the insoluble complex.
